(19) United States
(12) Patent Application Publication
(10) Pub. No.: US 2026/0153666 A1
(43) Pub. Date: Jun. 4, 2026

(54) BACKLIGHT MODULE AND DISPLAY DEVICE

(71) Applicant: WUHAN CHINA STAR OPTOELECTRONICS TECHNOLOGY CO., LTD., Wuhan, Hubei (CN)

(72) Inventors: Mengjie LI, Wuhan, Hubei (CN); Qing GUO, Wuhan, Hubei (CN); Yuanyuan REN, Wuhan, Hubei (CN); Tengfei LOU, Wuhan, Hubei (CN); Pan DONG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/705,507

(22) PCT Filed: Apr. 7, 2024
(86) PCT No.: PCT/CN2024/086449

§ 371 Date: Apr. 26, 2024

(30) Foreign Application Priority Data
Mar. 13, 2024 (CN) 202410288448.1

(51) Int. Cl. F21V 8/00; G02F 1/1335; G02F 1/13357

(52) U.S. Cl. CPC G02B 6/0068; G02B 6/0035; G02B 6/0076; G02F 1/133514; G02F 1/133601; G02F 1/133615

(57) ABSTRACT

The present application discloses a backlight module and a display device. A light exiting direction of a first light bar intersects a light exiting direction of a second light bar. The first light bar includes at least two first partitions. The second light bar includes at least two second partitions. When the backlight module is in the first state, brightness of adjacent two of at least two first partitions is different, and brightness of adjacent two of at least two second partitions is different.

### FIELD OF INVENTION

The present application relates to a field of display technologies, especially to a backlight module and a display device.

### BACKGROUND OF INVENTION

As liquid crystal display screens advance, people's demands for the appearance and functionality of display screens are also increasing. High contrast is a development direction for modules. Improving contrast can give images a greater sense of depth. Currently, the general method for increasing contrast is to adjust the liquid crystals inside the liquid crystal display.

In backlight modules, the method for improving contrast is generally only through local dimming of a direct-lit Mini light emitting diode (LED). The principle of local dimming of Mini LEDs is to divide the Mini LEDs into fixed small regions, with each region independently controlling brightness, which can significantly improve contrast.

On the other hand, side-lit backlight modules provide a light source through a light bar, which is then converted into an area light source by a light guide plate. They cannot achieve a local dimming function. Therefore, current side-lit backlight modules have difficulty in effectively improving the contrast of display screens.

### SUMMARY OF INVENTION

The embodiment of the present application provides a backlight module and a display device that can achieve a local dimming function of a side-lit backlight module to improve a contrast of a display device.

An embodiment of the present application provides a backlight module, comprising:
a light guide plate assembly, wherein the light guide plate assembly comprises a collimation-type light guide plate;
a first light bar disposed on a side surface of the light guide plate assembly, wherein a light exiting direction of the first light bar faces the light guide plate assembly and emits light along a first direction; and
a second light bar disposed on a side surface of the light guide plate assembly, wherein a light exiting direction of the second light bar faces the light guide plate assembly and emits light along a second direction, and the first direction intersects the second direction;
wherein the first light bar comprises at least two first partitions and a first light emitting member disposed in each of the first partitions, the second light bar comprises at least two second partitions and a second light emitting member disposed in each of the second partitions, the backlight module comprises a first state, when the backlight module is in the first state, brightness of adjacent two of the first partitions in the at least two first partitions is different, and brightness of adjacent two of the second partitions in the at least two second partitions is different.

According to the above objective of the present application, the embodiment of the present application further provides a display device, the display device comprises a backlight module and a display panel, and the display panel is disposed on a light exiting side of the backlight module;
the backlight module comprises:
a light guide plate assembly, wherein the light guide plate assembly comprises a collimation-type light guide plate;
a first light bar disposed on a side surface of the light guide plate assembly, wherein a light exiting direction of the first light bar faces the light guide plate assembly and emits light along a first direction; and
a second light bar disposed on a side surface of the light guide plate assembly, wherein a light exiting direction of the second light bar faces the light guide plate assembly and emits light along a second direction, and the first direction intersects the second direction;
wherein the first light bar comprises at least two first partitions and a first light emitting member disposed in each of the first partitions, the second light bar comprises at least two second partitions and a second light emitting member disposed in each of the second partitions, the backlight module comprises a first state, when the backlight module is in the first state, brightness of adjacent two of the first partitions in the at least two first partitions is different, and brightness of adjacent two of the second partitions in the at least two second partitions is different.

### DESCRIPTION OF DRAWINGS

Specific embodiments of the present invention are described in details with accompanying drawings as follows to make technical solutions and advantages of the present invention clear.

FIG. 1 is a schematic structural view of a backlight module provided by the related technology;

FIG. 2 is a schematic top structural view of the backlight module provided by the related technology;

FIG. 3 is a schematic top structural view of a backlight module provided by the embodiment of the present application;

FIG. 4 is a schematic cross-sectional structural view of the embodiment of the present application along a line AA in FIG. 3;

FIG. 5 is a schematic structural view of a first light guide plate provided by the embodiment of the present application;

FIG. 6 is a schematic structural view of a second light guide plate provided by the embodiment of the present application;

FIG. 7 is a schematic structural view of a first light bar provided by the embodiment of the present application;

FIG. 8 is a circuit schematic view of the first light bar provided by the embodiment of the present application;

FIG. 9 is another circuit schematic view of the first light bar provided by the embodiment of the present application;

FIG. 10 is another circuit schematic view of the first light bar provided by the embodiment of the present application;

FIG. 11 is another circuit schematic view of the first light bar provided by the embodiment of the present application;

FIG. 12 is another circuit schematic view of the first light bar provided by the embodiment of the present application;

FIG. 13 is another schematic cross-sectional structural view of the embodiment of the present application along a line AA in FIG. 3;

FIG. 14 is another schematic cross-sectional structural view of the first light guide plate provided by the embodiment of the present application;

FIG. 15 is another schematic cross-sectional structural view of the first light guide plate provided by the embodiment of the present application;

FIG. 16 is a schematic distribution view of a first display surface of the first light guide plate provided by the embodiment of the present application;

FIG. 17 is a schematic distribution view of a second display surface of the second light guide plate provided by the embodiment of the present application;

FIG. 18 is a schematic distribution view of a display surface of a light guide plate assembly provided by the embodiment of the present application;

FIG. 19 is another schematic distribution view of the first display surface of the first light guide plate provided by the embodiment of the present application;

FIG. 20 is another schematic distribution view of the second display surface of the second light guide plate provided by the embodiment of the present application;

FIG. 21 is another schematic distribution view of the display surface of the light guide plate assembly provided by the embodiment of the present application;

FIG. 22 is another schematic top structural view of the backlight module provided by the embodiment of the present application;

FIG. 23 is a schematic cross-sectional structural view of the embodiment of the present application along a line BB in FIG. 22;

FIG. 24 is a schematic cross-sectional structural view of the embodiment of the present application along a line CC in FIG. 22;

FIG. 25 and FIG. 26 are schematic structural views of the first light guide plate provided by the embodiment of the present application;

FIG. 27 and FIG. 28 are schematic structural views of the second light guide plate provided by the embodiment of the present application;

FIG. 29 is another schematic cross-sectional structural view of the embodiment of the present application along the line BB in FIG. 22;

FIG. 30 is another schematic cross-sectional structural view of the embodiment of the present application along the line CC in FIG. 22;

FIG. 31 is another schematic structural view of the first light guide plate provided by the embodiment of the present application;

FIG. 32 is another schematic structural view of the second light guide plate provided by the embodiment of the present application;

FIG. 33 is another schematic top structural view of the backlight module provided by the embodiment of the present application;

FIG. 34 is a schematic cross-sectional structural view of the embodiment of the present application along a line DD in FIG. 33;

FIG. 35 is a schematic cross-sectional structural view of the embodiment of the present application along a line EE in FIG. 33;

FIG. 36 and FIG. 37 are another schematic structural views of the second light guide plate provided by the embodiment of the present application;

FIG. 38 is a schematic distribution view of the display surface of the light guide plate assembly provided by the embodiment of the present application;

FIG. 39 is another schematic distribution view of the display surface of the light guide plate assembly provided by the embodiment of the present application;

FIG. 40 is another schematic distribution view of the display surface of the light guide plate assembly provided by the embodiment of the present application;

FIG. 41 is another schematic distribution view of the display surface of the light guide plate assembly provided by the embodiment of the present application;

FIG. 42 is another schematic distribution view of the display surface of the light guide plate assembly provided by the embodiment of the present application;

FIG. 43 is another schematic distribution view of the display surface of the light guide plate assembly provided by the embodiment of the present application;

FIG. 44 is another schematic cross-sectional structural view of the embodiment of the present application along a line DD in FIG. 43;

FIG. 45 is another schematic cross-sectional structural view of the embodiment of the present application along a line EE in FIG. 43;

FIG. 46 is another schematic structural view of the first light guide plate provided by the embodiment of the present application;

FIG. 47 is another schematic structural view of the first light guide plate provided by the embodiment of the present application;

FIG. 48 is a schematic structural view of first light guide structures provided by the embodiment of the present application;

FIG. 49 is a schematic structural view of a display device provided by the embodiment of the present application;

FIG. 50 is a verification display image of the display device provided by the embodiment of the present application;

FIG. 51 is another verification display image of the display device provided by the embodiment of the present application;

FIG. 52 is a display image schematic view of the display device provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

The following disclosure provides many different embodiments or examples to achieve different structures of the present application. To simplify the disclosure of the present application, the components and arrangements of the specific examples are described below. Of course, they are merely examples, and the purpose is not to limit the present application. Furthermore, the present application may repeat reference numerals and/or reference letters in different examples. The repetition is for the purpose of simplification and clarity, and does not by itself indicate the relationship between the various embodiments and/or settings discussed. In addition, the present application provides examples of various specific processes and materials, but a person of ordinary skill in the art can be aware of the application of other processes and/or the use of other materials.

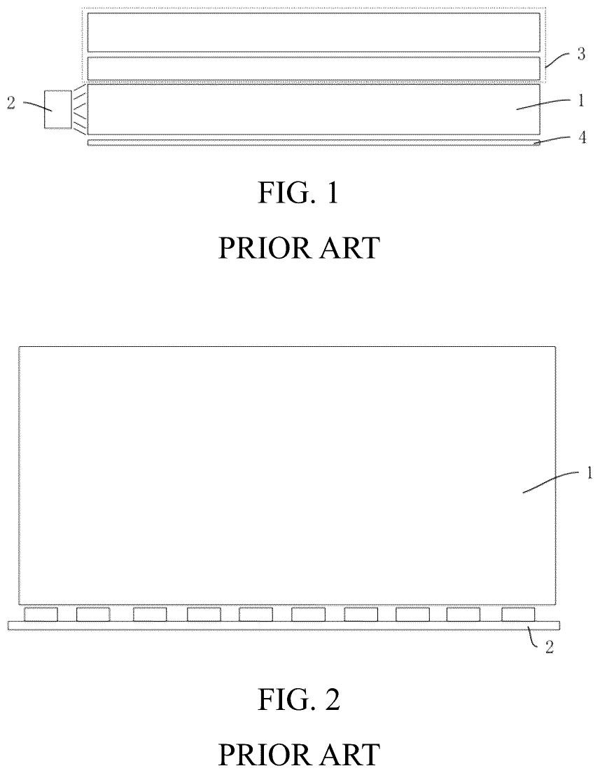

With reference to FIGS. 1 and 2, a side-lit backlight module provided by the related technology is disclosed. The backlight module comprises a light guide plate 1, a light bar 2 disposed on a side surface of the light guide plate 1, an optical film 3 disposed on a light exiting side of the light guide plate 1, and a reflective sheet 4 disposed on a side of the light guide plate 1 away from optical film 2. The optical film 3 comprises a diffuser plate and a prism piece. The light bar 2 provides a light source in which the light guide plate 1 converts the linear light source into an area light source, which cannot achieve a local dimming function. Therefore, the conventional side-lit backlight module cannot perform a function improving a contrast of the display screen.

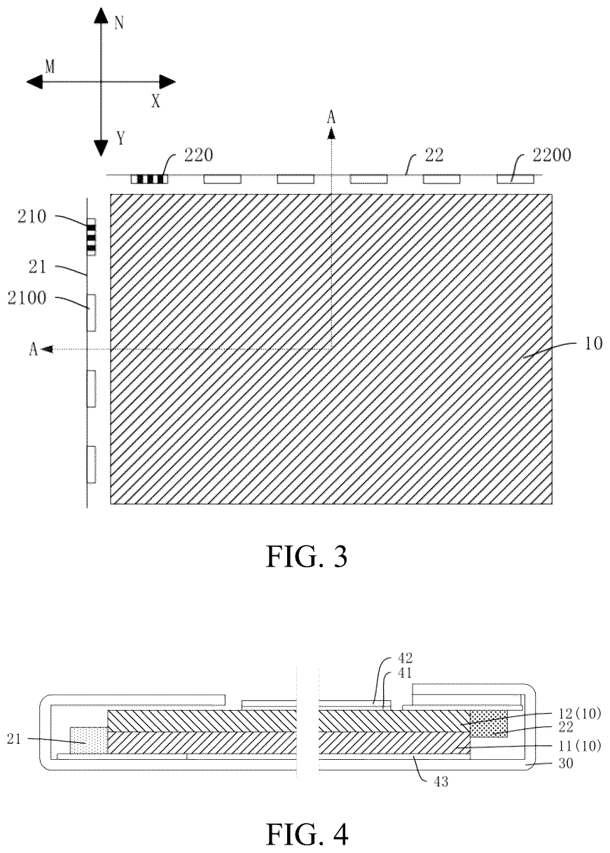

With reference to FIGS. 3 and 4, the embodiment of the present application provides a backlight module, and the backlight module comprises a light guide plate assembly 10, a first light bar 21, and a second light bar 22.

The light guide plate assembly 10 comprises a collimation-type light guide plate. The first light bar 21 is disposed on a side surface of the light guide plate assembly 10. A light exiting direction of the first light bar 21 faces the light guide plate assembly 10 and emits light along a first direction X. The second light bar 22 is disposed on a side surface of the light guide plate assembly 10. A light exiting direction of the second light bar 22 faces the light guide plate assembly 10 and emits light along a second direction Y. The first direction X intersects the second direction Y.

Furthermore, the first light bar 21 comprises at least two first partitions 2100 and a first light emitting member 210 disposed in each of the first partitions 2100. The second light bar 22 comprises at least two second partitions 2200 and a second light emitting member 220 disposed in each of the second partitions 2200. The backlight module comprises a first state. When the backlight module is in the first state, brightness of adjacent two of the first partitions 2100 in the at least two first partitions 2100 is different, and in brightness of adjacent two of the second partitions 2200 in the at least two second partitions 2200 is different.

In the implementation of the embodiment, the embodiment of the present application disposes the first light bar 21 and the second light bar 22 on a side surface of the light guide plate assembly 10, and the light exiting direction of the first light bar 21 intersects the light exiting direction of the second light bar 22. Thus, when brightness of adjacent ones of the first partitions 2100 in the first light bar 21 is different and brightness of adjacent ones of the second partitions 2200 in the second light bar 22 is different, a checkerboard lattice light exiting surface having different brightness regions can be formed on a light exiting side of the light guide plate assembly 10, which can achieve a local dimming function of the backlight module and improve a contrast of the display device.

In an embodiment of the present application, the light guide plate assembly comprises a first light guide plate, the first light bar is disposed on a side surface of the first light guide plate, and the light exiting direction of the first light bar faces the first light guide plate, a plurality of first light guide structures are disposed on a surface of the first light guide plate away from a light exiting side of the backlight module, and the first light guide structure comprises a first light guide surface disposed opposite to the first light bar.

In an embodiment of the present application, the second light bar is disposed on a side surface of the first light guide plate, the light exiting direction of the second light bar faces the first light guide plate, and the first light guide structure comprises a second light guide surface disposed opposite to the second light bar;
or, the light guide plate assembly further comprises a second light guide plate stacked with the first light guide plate, the second light bar is disposed on a side surface of the second light guide plate, the light exiting direction of the second light bar faces the second light guide plate, a plurality of second light guide structures are disposed on a surface of the second light guide plate away from the light exiting side of the backlight module, and the second light guide structure comprises a second light guide surface disposed opposite to the second light bar.

In an embodiment of the present application, an included angle between the first light guide surface and the first direction is less than 90°, and an included angle between the second light guide surface and the second direction is less than 90°.

In an embodiment of the present application, the backlight module further comprises a third light bar disposed on the light guide plate assembly side surface, a light exiting direction of the third light bar faces the light guide plate assembly and emit light along a third direction, and the third direction is opposite to the first direction; and
wherein the third light bar comprises at least two third partitions and a third light emitting member disposed in each of the third partitions, and when the backlight module is in the first state, brightness of adjacent two of the third partitions in the at least two third partitions is different.

In an embodiment of the present application, the third light bar is disposed on a side surface of the first light guide plate and emit light toward the first light guide plate, and the first light guide plate comprises a third light guide surface disposed opposite to the third light bar.

In an embodiment of the present application, a plurality of third light guide structures are disposed on the surface of the first light guide plate away from the light exiting side of the backlight module, the third light guide structure comprises the third light guide surface disposed opposite to the third light bar, wherein the first light guide structures disposed along the first direction constitute a first light guide set, the third light guide structures disposed along the third direction constitute a third light guide set, the first light guide plate comprises a plurality of the first light guide sets and a plurality of second light guide sets arranged alternately along a direction perpendicular to the first direction;
or, the first light guide structure comprises the third light guide surface disposed opposite to the third light bar.

In an embodiment of the present application, the third light bar is disposed on a side surface of the second light guide plate and emits light toward the second light guide plate, and the second light guide plate comprises a third light guide surface disposed opposite to the third light bar.

In an embodiment of the present application, an included angle between the third light guide surface and the third direction is less than 90°.

In an embodiment of the present application, the at least two first partitions are aligned with the at least two third partitions along the first direction, and brightness of the first partitions and the third partitions aligned with each other along the first direction is the same; and
or, the at least two first partitions are misaligned with the at least two third partitions along the first direction, each of the first partitions corresponds to a location between adjacent two of the third partitions along the first direction, and brightness of each of the first partitions is different from brightness of the adjacent two of the third partitions corresponding to the first partition.

In an embodiment of the present application, the backlight module further comprises a fourth light bar disposed on the light guide plate assembly side surface, a light exiting direction of the fourth light bar faces the light guide plate assembly along emits light along a fourth direction, and the fourth direction is opposite to the second direction;
wherein the fourth light bar comprises at least two fourth partitions and at least one fourth light emitting member disposed in each of the fourth partitions, and when the backlight module is in the first state, adjacent brightness of two of the fourth partitions in the at least two fourth partitions is different.

In an embodiment of the present application, the fourth light bar is disposed on a side surface of the first light guide plate and emit light toward the first light guide plate, and the first light guide structure comprises a fourth light guide surface disposed opposite to the fourth light bar.

In an embodiment of the present application, the fourth light bar is disposed on a side surface of the second light guide plate and emits light toward the second light guide plate, the second light guide plate comprises a fourth light guide surface disposed opposite to the fourth light bar.

In an embodiment of the present application, a plurality of fourth light guide structures are disposed on a side surface of the second light guide plate away from the light exiting side of the backlight module, the fourth light guide structure comprises a fourth light guide surface disposed opposite to the fourth light bar, wherein the second light guide structures arranged along the second direction constitute a second light guide set, the fourth light guide structures arranged along the fourth direction constitute a fourth light guide set, and the second light guide plate comprises the second light guide sets and the fourth light guide sets arranged alternately along a direction perpendicular to the second direction;
or, the second light guide structure comprises the fourth light guide surface disposed opposite to the fourth light bar.

In an embodiment of the present application, an included angle between the fourth light guide surface and the fourth direction is less than 90°.

In an embodiment of the present application, the at least two second partitions are aligned with the at least two fourth partitions along the second direction, brightness of the second partitions and the fourth partitions aligned with each other along the second direction is the same;
or, the at least two second partitions are misaligned with the at least two fourth partitions along the second direction, each of the second partitions along the second direction corresponds to a location between adjacent two of the fourth partitions, and brightness of each of the second partitions is different from brightness of adjacent two of the fourth partitions corresponding to the second partition.

In an embodiment of the present application, the backlight module comprises a plurality of first driver chips and a plurality of the second driver chips, the first driver chips are electrically connected to the first light emitting members in the first partitions, and the second driver chips are electrically connected to the second light emitting members in the second partitions;
adjacent two of the first partitions are connected to different ones of the first driver chips, and adjacent two of the second partitions are connected to different ones of the second driver chips.

In an embodiment of the present application, a light emitting angle of the first light emitting member is less than or equal to 120°, and a light emitting angle of the second light emitting member sis less than or equal to 120°.

In an embodiment of the present application, a light exiting side of the light guide plate assembly near the backlight module comprises light exiting surface;
when the backlight module is in the first state, the light exiting surface comprises a plurality of first light emitting regions extending along the first direction arranged along a direction perpendicular to the first direction, light emitting brightness of adjacent two of the first light emitting regions is different, and each of the first light emitting regions along the first direction corresponds to one of the first partitions;
the light exiting surface comprises a plurality of second light emitting regions extending along the second direction and arranged along a direction perpendicular to the second direction, light emitting brightness of adjacent two of the second light emitting regions is different, and each of the second light emitting regions along the second direction corresponds to one of the second partitions.

In an embodiment of the present application, the first light bar comprises a plurality of the first partitions, and light emitting brightness of each of the first partitions is one of at least three different brightness; and
the second light bar comprises a plurality of second partitions, and light emitting brightness of each of the second partitions is one of at least three different brightness.

In an embodiment of the present application, the display panel comprises an array substrate and a color filter substrate disposed opposite to each other, a liquid crystal layer disposed between the array substrate and the color filter substrate, and a compensation module, the compensation module is electrically connected to the array substrate and/or the color filter substrate, the compensation module is configured to control liquid crystal molecules in the liquid crystal layer to deflect to compensate brightness of different regions of the display device.

In particular, with further reference to FIGS. 3 and 4, a backlight module provided by the embodiment of the present application comprises a frame body 30, a light guide plate assembly 10 disposed in the frame body 30, a first light bar 21, a second light bar 22 and optical film. The optical film can comprise a reflective sheet 43, a diffuser plate 41 and a composite film 42.

The reflective sheet 43 is disposed on a bottom plate of the frame body 30. The light guide plate assembly 10 is disposed on a side of the reflective sheet 43 away from the frame body 30. Both the first light bar 21 and the second light bar 22 are disposed on a side surface of the light guide plate assembly 10, and both the light exiting direction of the first light bar 21 and the light exiting direction of the second light bar 22 face the light guide plate assembly 10. A side of the light guide plate assembly 10 away from the reflective sheet 43 is a light exiting surface. The diffuser plate 41 and the composite film 42 layer is disposed on a light exiting side of the light guide plate assembly 10. An aperture is defined in a side of the frame body 30 near the light exiting surface of the light guide plate assembly 10 such that light emitted by the first light bar 21 and the second light bar 22 can be emitted out from the aperture after passing through the light guide plate assembly 10 and the optical film and make the backlight module provide backlight.

It should be explained that the backlight module provided by the embodiment of the present application is a side-lit type. The first light bar 21 and the second light bar 22 are located on different side surfaces of the light guide plate assembly 10. The first light bar 21 emits light along the first direction X, the second light bar 22 emits light along the second direction Y, and the first direction X intersects the second direction Y.

In an embodiment, the first direction X is perpendicular to the second direction Y.

The first light bar 21 comprises at least two first partitions 2100 and at least one first light emitting member 210 disposed in each of the first partitions 2100. The second light bar 22 comprises the at least two second partitions 2200 and the at least one second light emitting member 220 disposed in each of the second partitions 2200.

During embodying of the present application, the backlight module comprises a first state. When the backlight module is in the first state, light emitting brightness of adjacent two of the first partitions 2100 is different, and light emitting brightness of adjacent two of the second partitions 2200 is different. Also, because light emitting directions of the first light bar 21 and the second light bar 22 intersect each other, light emitted from the first partitions 2100 and light emitted from the second partitions 2200 form a plurality of checkerboard lattice regions of different brightness in the light guide plate assembly 10. Furthermore, brightness of each of the checkerboard lattice regions can be adjusted according to light emitting brightness and overlay brightness of the first partitions 2100 and the second partitions 2200 to achieve a local dimming function of the backlight module, thereby improving a contrast of the display device comprising the backlight module.

It should be explained that the backlight module further comprises a second state. When the backlight module is in the second state, and one of the first light bar 21 and the second light bar 22 emits light to lower a power consumption of the backlight module. Also, under the second state, the local dimming function cannot be implemented, the second state of the backlight module can be used on the display device to display a simple display with a single image. Thus, the first state of the backlight module can be deemed as a high contrast state, and the second state of the backlight module can be deemed as a regular state.

Furthermore, because the embodiment of the present application designs the light emitting brightness of adjacent ones of the first partitions 2100 of the first light bar 21 and the light emitting brightness of adjacent ones of the second partitions 2200 of the second light bar 22, it is required that light emitted from the first partitions 2100 and the second partitions 2200 would not diverge in the light guide plate assembly 10. Therefore, the light guide plate assembly 10 comprises a collimation-type light guide plate to improve a convergence ability of the light guide plate assembly 10 to light emitted from the first light bar 21 and the second light bar 22 such that checkerboard lattice regions of different brightness can be formed smoothly in the light guide plate assembly 10 to achieve a local dimming function of the backlight module.

In an embodiment, a light emitting angle of the first light emitting member 210 is less than or equal to 120°, and a light emitting angle of the second light emitting member 220 is less than or equal to 120°, which can improve light emission convergence degrees of different ones of the first partitions 2100 of the first light bar 21 and light emission convergence degrees of different ones of the second partitions 2200 in the second light bar 22. Furthermore, the light emitting angle of the first light emitting member 210 is greater than or equal to 90°, and the light emitting angle of the second light emitting member 220 is greater than or equal to 90°, thereby preventing an obvious dividing line among light emitted from adjacent ones of the first light emitting member 210 in the first partitions 2100 and preventing the second partitions 2200 and an obvious dividing line among light emitted from adjacent ones of the second light emitting member 220 in the second partitions 2200 to further improve light emission consistency of each of the first partitions 2100 and light emission consistency of each of the second partitions 2200, which facilitates formation of predetermined checkerboard lattice regions.

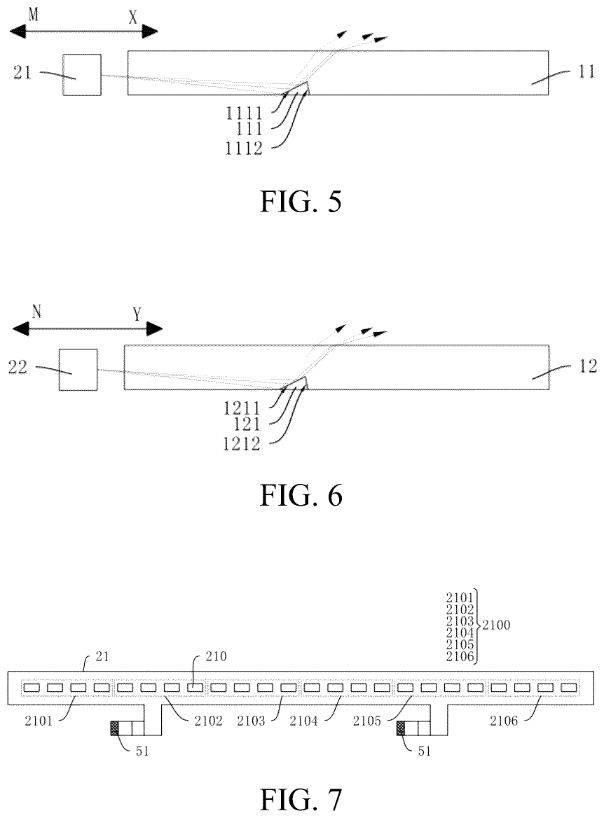

With reference to FIGS. 3, 4, 5, and 6, the light guide plate assembly 10 comprises a first light guide plate 11 and a second light guide plate 12 stacked on each other, the first light bar 21 is disposed on a side surface of the first light guide plate 11, and the second light bar 22 is disposed on a side surface of the second light guide plate 12. The first light bar 21 emits light toward the first light guide plate 11 along the first direction X, and the second light bar 22 emits light toward the second light guide plate 12 along the second direction Y.

It can be understood that each of the first light guide plate 11 and the second light guide plate 12 can be a collimation-type light guide plate.

In an embodiment, a plurality of first light guide structures 111 are disposed on a side of the first light guide plate 11 away from the light exiting surface of the light guide plate assembly 10. The first light guide structure 111 comprises a first light guide surface 1111 disposed near a side of the first light bar 21, and an included angle between the first light guide surface 1111 and the first direction X is less than 90°. A plurality of second light guide structures 121 are disposed on a side of the second light guide plate 12 away from the light exiting surface, the second light guide structures 121 comprises a second light guide surface 1211 disposed near a side of the second light bar 22, and an included angle between the second light guide surface 1211 and the second direction Y is less than 90°.

Furthermore, an opposite direction of the first direction X is defined as a third direction M, and an opposite direction of the second direction Y is defined as a fourth direction N. The first light guide structure 111 further comprises a first rear surface 1112 disposed away from a side of the first light bar 21, and an included angle between the first rear surface 1112 and the third direction M is greater than an included angle between the first light guide surface 1111 and the first direction X. The second light guide structures 121 further comprises a second rear surface 1212 disposed away from a side of the second light bar 22, and an included angle between the second rear surface 1212 and the fourth direction N is greater than an included angle between the second light guide surface 1211 and the second direction Y such that light emitted from the first light bar 21 and the second light bar 22 can converge in the first light guide plate 11 and the second light guide plate 12.

In an embodiment, both the first light guide surface 1111 and the second light guide surface 1211 are planes.

In the embodiment of the present application, light emitting brightness of adjacent two of the first partitions 2100 in the first light bar 21 is different, and light emitting brightness of adjacent two of the second partitions 2200 in the second light bar 22 is different. Therefore, adjacent two of the first partitions 2100 in the first light bar 21 are driven by different driver chips, and adjacent two of the second partitions 2200 in the second light bar 22 are driven by different driver chips.

In particular, with reference to FIGS. 4, 7, 8, and 9, the backlight module comprises a plurality of first driver chips 51. The first driver chips 51 is electrically connected to the first light emitting member 210 in the first partitions 2100, and adjacent two of the first partitions 2100 are connected to different first driver chips 51.

The first partitions 2100 disposed at intervals are connected to one of the first driver chips 51 such that the first light bar 21 can only be driven by two first driver chips 51. In particular, the first light bar 21 comprises a plurality of first partitions 2100, and the first partitions 2100 comprise a first partition 2101, a first partition 2102, a first partition 2103, a first partition 2104, a first partition 2105, and a first partition 2106 sequentially arranged. Also, the first partition 2101, the first partition 2103 and the first partition 2105 disposed at intervals are driven by one first driver chip 51, and the first partition 2102, the first partition 2104, and the first partition 2106 disposed at intervals are driven by another first driver chip 51 to achieve adjacent two of the first partitions 2100 driven by different ones of the first driver chips 51 such that light emitting brightness of adjacent two of the first partitions 2100 is different.

In another embodiment of the present application, each of the first partitions 2100 can also be driven by a single first driver chip 51 to further achieve individual light control for each of the first partition 2100 to improve a refinement degree of the local dimming of the backlight module.

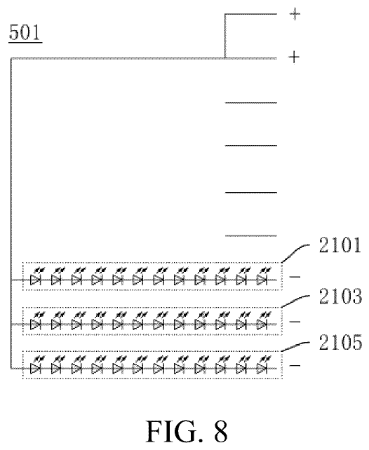

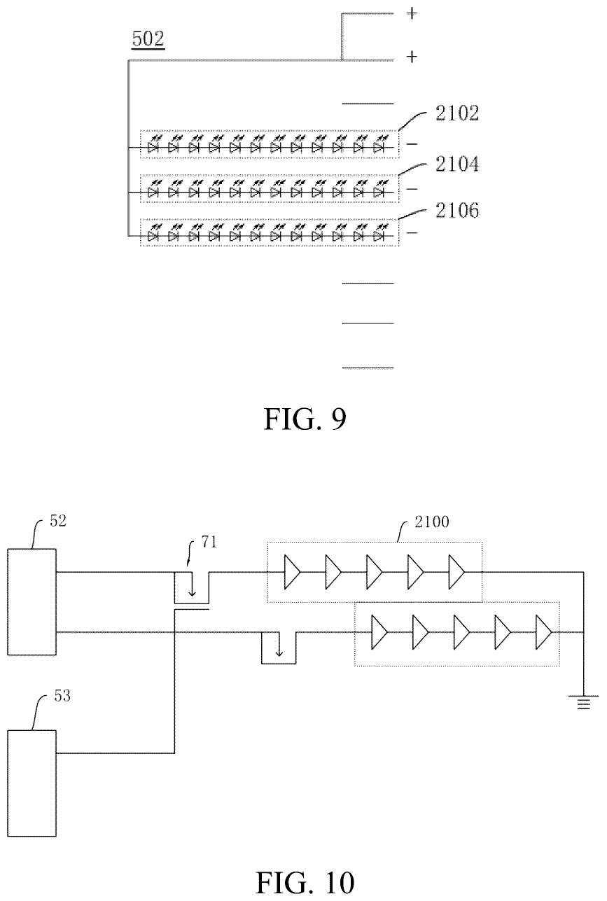

In an embodiment, the first light bar 21 can comprise wirings, for example, a first wiring 501 and a second wiring 502, and the first wiring 501 is connected to the first partition 2101, the first partition 2103, and the first partition 2105, as shown in FIG. 8. The second wiring 502 is connected to the first partition 2102, the first partition 2104, and the first partition 2106, as shown in FIG. 9.

Moreover, the backlight module further comprises a plurality of second driver chips, the second driver chips are electrically connected to the second light emitting members 220 in the second partitions 2200, and adjacent two of the second partitions 2200 correspond to different ones of the second driver chips. It can be understood that a disposing method and a wiring connection method of the second driver chips in the second light bar 22 can be configured by referring to the disposing method and the wiring connection method of the first driver chips 51 in the first light bar 21 as shown in FIGS. 7, 8, and 9. Alternatively, each of the second partitions 2200 can be driven by a single second driver chip, and no repeated description is here.

In another embodiment, with reference to FIG. 10, all of the first partitions 2100 on the first light bar 21 are connected to the same light emission driver chip 52, to provide the first partitions 2100 with driving currents. FIG. 10 uses two first partitions 2100 as an example for explanation. a switch device 71 is disposed on a connection wiring between each of the first partitions 2100 and the light emission driver chip 52. In each adjacent two of the first partitions 2100, the switch device 71 correspondingly connected to one of the first partitions 2100 is connected to an on/off module 53, and the on/off module 53 can be used to control a corresponding one of the first partitions 2100 inputted with the driving current or not to further make adjacent two of the first partitions 2100 implement different brightness such as bright and dark brightness. The on/off module 53 comprises a time controller or a driver chip.

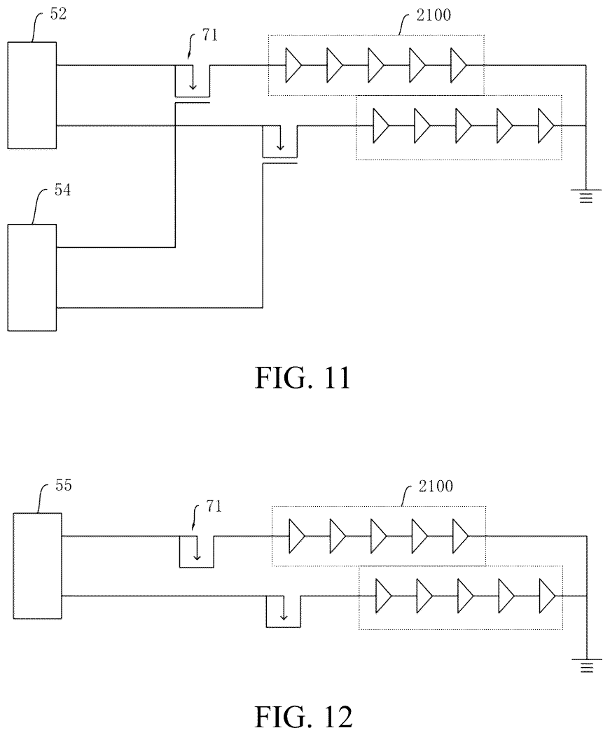

In another embodiment, with reference to FIG. 11, a difference of the present embodiment from the embodiment in FIG. 10 is that: the switch device 71 correspondingly connected to each of the first partitions 2100 is connected to a current control chip 54, and the current control chip 54 can control the switch device 71 to further control whether a driving current is inputted in each of the first partitions 2100 or not and a value of the driving current, which can further achieve two different brightness of adjacent two of the first partitions 2100 and also implement a fine control to the brightness of each of the first partitions 2100, thereby achieving three different brightness or more of the first partitions 2100.

In another embodiment, with reference to FIG. 12, a difference of the present embodiment from the embodiment of FIG. 11 is that: The light emission driver chip 52 and the current control chip 54 are integrated together to form an integrated driver chip 55, and the first partitions 2100 are connected to the same integrated driver chip 55. The integrated driver chip 55 is used to control whether a driving current is inputted in each of the first partitions 2100 or not and a value of the driving current, which can further achieve two different brightness of adjacent two of the first partitions 2100 and also implement a fine control to the brightness of each of the first partitions 2100, thereby achieving three different brightness or more of the first partitions 2100.

Similarly, a light emitting driving method for the second partitions 2200 in the second light bar 22 can also be configured by referring to the driving method for the first partitions 2100 in the first light bar 21 in FIGS. 10, 11, and 12.

In an embodiment, the brightness of the first partitions 2100 comprises bright brightness and dark brightness, and the bright brightness and the dark brightness of the first partitions 2100 are arranged alternately. The brightness of the second partition 2200 comprises bright brightness and dark brightness, and the bright brightness and the dark brightness of the second partitions 2200 are arranged alternately.

In another embodiment, the light emitting brightness of each of the first partitions 2100 is one of at least three different brightness, and the light emitting brightness of each of the second partitions 2200 is one of at least three different brightness.

In particular, brightness of the first partitions 2100 comprises a plurality of gradients, for example, the brightness of the first partitions 2100 comprises first brightness, second brightness, third brightness, fourth brightness, and fifth brightness, and the first brightness is greater than the second brightness, the second brightness is greater than the third brightness, the third brightness is greater than the fourth brightness, the fourth brightness is greater than the fifth brightness. Also, the brightness of each of the first partitions 2100 is individually selected from the first brightness, the second brightness, the third brightness, the fourth brightness, and the fifth brightness. Moreover, the brightness of adjacent ones of the first partitions 2100 is different.

Similarly, the brightness of the second partition 2200 comprises a plurality of gradients, for example, the brightness of the second partition 2200 comprises sixth brightness, seventh brightness, eighth brightness, ninth brightness, and tenth brightness. The sixth brightness is greater than the seventh brightness, the seventh brightness is greater than the eighth brightness, the eighth brightness is greater than the ninth brightness, and the ninth brightness is greater than the tenth brightness. The brightness of each of the second partitions 2200 is individually selected from the sixth brightness, the seventh brightness, the eighth brightness, the ninth brightness, and the tenth brightness, and the brightness of adjacent ones of the second partitions 2200 is different.

It can be understood that a quantity of the above brightness gradients is not limited, and can be three, four, six, or more, and can be selected according to actual demands to obtain a contrast and a display effect satisfying the demands.

It should be explained that because the backlight module provided by the embodiment of the present application comprises the first light guide plate 11 and the second light guide plate 12 stacked on each other and the quantity of the light guide plates is more than the quantity of the light guide plates in the backlight module provided by the related technology, the embodiment of the present application needs to reduce thicknesses of the first light guide plate 11 and the second light guide plate 12 and make the thickness of the first light guide plate 11 less than 0.6 mm and the thickness of the second light guide plate 12 less than 0.6 mm to further prevent an excessive thickness of the backlight module due to increase of the quantity of the light guide plates.

Furthermore, the embodiment of the present application utilizes the composite film 42, the composite film 42 can be a complex formed by a diffuser plate and a prism piece, and the composite film 42 comprises functions of the diffuser plate and the prism piece, but a thickness of the complex is less than a sum of thicknesses of the individual diffuser plate and prism piece such that the thickness of the backlight module can be increased less or keep constant compared to the related technology.

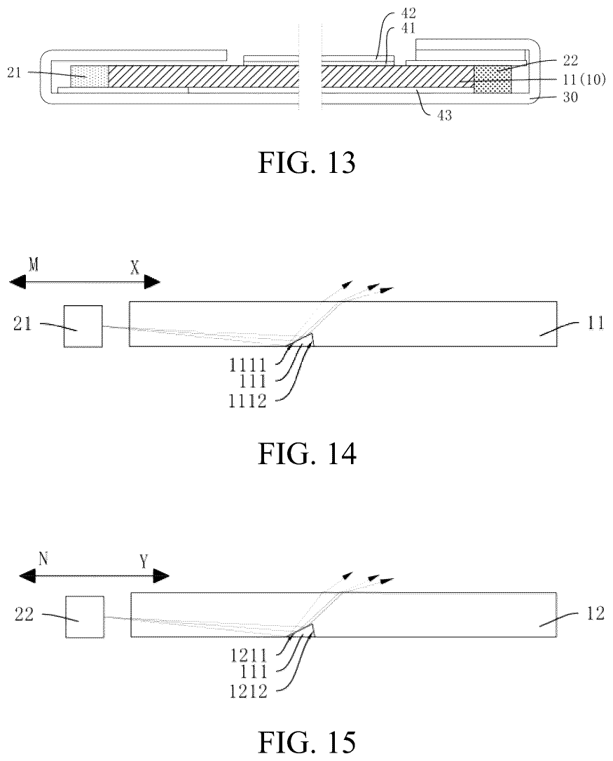

In another embodiment of the present application, with reference to FIGS. 3, 13, 14, and 15, a difference of the present embodiment from the embodiment of FIG. 4 embodiment is that: The light guide plate assembly 10 comprises a light guide plate, in particular, the light guide plate assembly 10 only comprises the first light guide plate 11.

The first light bar 21 is disposed on a side surface of the first light guide plate 11, and the light exiting direction of the first light bar 21 faces the first light guide plate 11. A plurality of first light guide structures 111 are disposed on a surface of the first light guide plate 11 away from the light exiting side of the backlight module. The first light guide structure 111 comprises a first light guide surface 1111 disposed opposite to the first light bar 21.

Furthermore, the second light bar 22 is disposed on a side surface of the first light guide plate 11, and the light exiting direction of the second light bar 22 faces the first light guide plate 11. The first light guide structure 111 comprises a second light guide surface 1211 disposed opposite to the second light bar 22.

An included angle between the first light guide surface 1111 and the first direction X is less than 90°, and an included angle between the second light guide surface 1211 and the second direction Y is less than 90°. The first light guide structure 111 further comprises a first rear surface 1112 disposed away from a side of the first light bar 21, and an included angle between the first rear surface 1112 and the third direction M is greater than the included angle between the first light guide surface 1111 and the first direction X. The first light guide structures 111 further comprises a second rear surface 1212 disposed away from a side of the second light bar 22, and an included angle between the second rear surface 1212 and the fourth direction N is greater than an included angle between the second light guide surface 1211 and the second direction Y such that light emitted from the first light bar 21 and the second light bar 22 can converge in the first light guide plate 11.

In another embodiment of the present application, when the first light bar 21 and the second light bar 22 are disposed on a side surface of the first light guide plate 11, a plurality of first light guide structures 111 and a plurality of second light guide structures (not shown in the figures) can be disposed on a surface of the first light guide plate 11 away from the light exiting side of the backlight module. Also, the second light guide structure comprises a second light guide surface 1211 disposed opposite to the second light bar 22, a location relationship between the second light guide surface 1211 and the second light bar 22 can be configured by referring to the above embodiment, and no repeated description is here.

Furthermore, In an embodiment of the present application, with reference to FIGS. 3, 4, 16, 17, and 18, a light exiting side of the light guide plate assembly 10 near the backlight module comprises a light exiting surface 100.

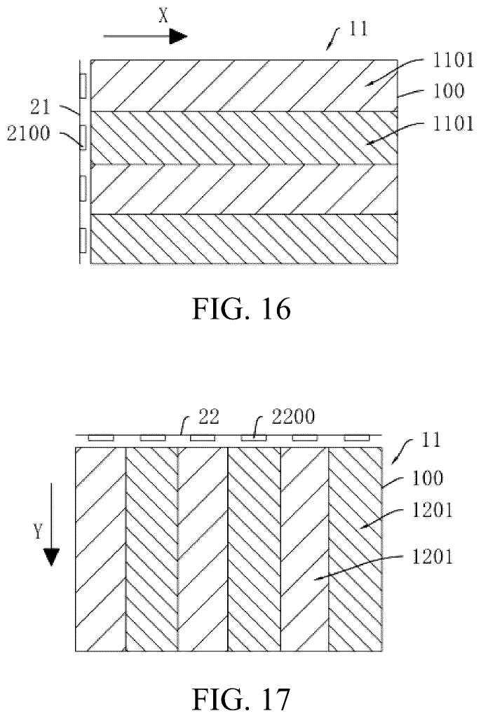

When the backlight module is in the first state, the light exiting surface 100 comprises a plurality of first light emitting regions 1101 extending along the first direction X and arranged along a direction perpendicular to the first direction X, for example, four first light emitting regions 1101. Light emitting brightness of adjacent two of the first light emitting regions 1101 is different. The light exiting surface 100 comprises a plurality of second light emitting regions 1201 extending along the second direction Y and arranged along a direction perpendicular to the second direction Y, for example, six second light emitting regions 1201. Light emitting brightness of adjacent two of the second light emitting regions 1201 is different, as shown in FIGS. 16 and 17.

Each of the first light emitting regions 1101 corresponds to one of the first partitions 2100 along the first direction X, and each of the second light emitting regions 1201 corresponds to one of the second partitions 2200 along the second direction Y.

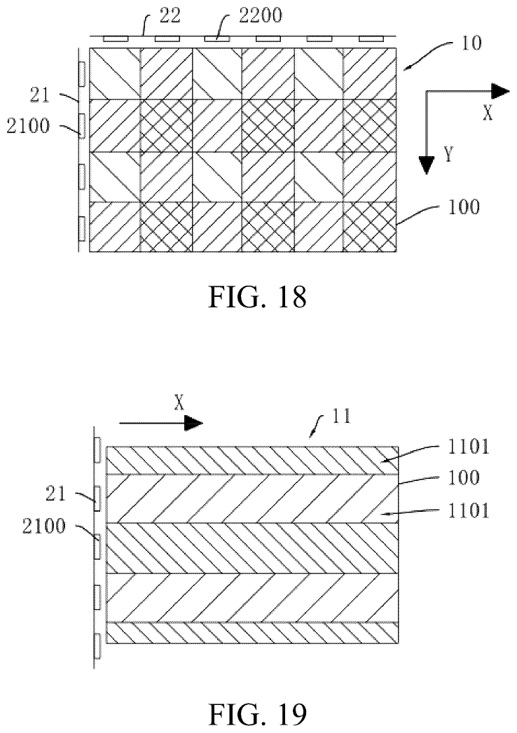

Furthermore, when the first light emitting regions 1101 intersect the second light emitting regions 1201 in the light exiting surface 100, a plurality of checkerboard lattice regions of different brightness can be formed in the light exiting surface 100, for example, twenty-four checkerboard lattice regions, as shown in FIG. 18, such that brightness levels of the backlight module are enhanced better, thereby achieving the local dimming function of the backlight module.

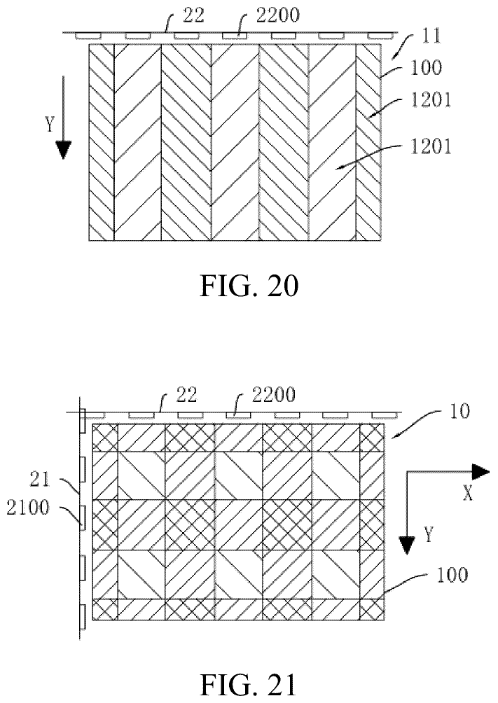

In another embodiment of the present application, with reference to FIGS. 3, 4, 19, 20, and 21, in the present embodiment, when the backlight module is in the first state, the light exiting surface 100 comprises a plurality of first light emitting regions 1101 extending along the first direction X and arranged along the direction perpendicular to the first direction X, for example, five first light emitting regions 1101. Light emitting brightness of adjacent two of the first light emitting regions 1101 is different. The light exiting surface 100 comprises a plurality of second light emitting regions 1201 extending along the second direction Y and arranged along the direction perpendicular to the second direction Y, for example, seven second light emitting regions 1201. Light emitting brightness of adjacent two of the second light emitting regions 1201 is different, as shown in FIGS. 19 and 20.

It can be understood that light emitted from the first partitions 2100 in the first light bar 21 converges in the first light guide plate 11 to form the first light emitting regions 1101, and light emitted from the second partitions 2200 in the second light bar 22 converges in the second light guide plate 12 to form the second light emitting regions 1201.

Because light emitted from the first light emitting member 210 and the second light emitting member 220 have a certain divergence, a width of the first light emitting regions 1101 is greater than a width of the first partitions 2100, and a width of the second light emitting region 1201 is greater than a width of the second partition 2200.

Furthermore, the first light emitting regions 1101 intersect the second light emitting regions 1201 to form a plurality of checkerboard lattice regions of different brightness in the light exiting surface 100, for example, thirty-five checkerboard lattice regions, as shown in FIG. 21, such that brightness levels of the backlight module are enhanced better, thereby achieving the local dimming function of the backlight module.

It should be explained that with the increase of the quantity of the first light emitting regions 1101 and the quantity of the second light emitting regions 1201 in the light exiting surface 100, the quantity of the checkerboard lattice regions finally formed in the light exiting surface 100 of the light guide plate assembly 10 become more, and brightness levels of the backlight module are enhanced better, and the contrast of the display device comprising the backlight module becomes higher. The first light emitting regions 1101 in the light exiting surface 100 correspond to the first partitions 2100 in the first light bar 21 respectively. The second light emitting regions 1201 in the light exiting surface 100 correspond to the second partitions 2200 in the second light bar 22 respectively.

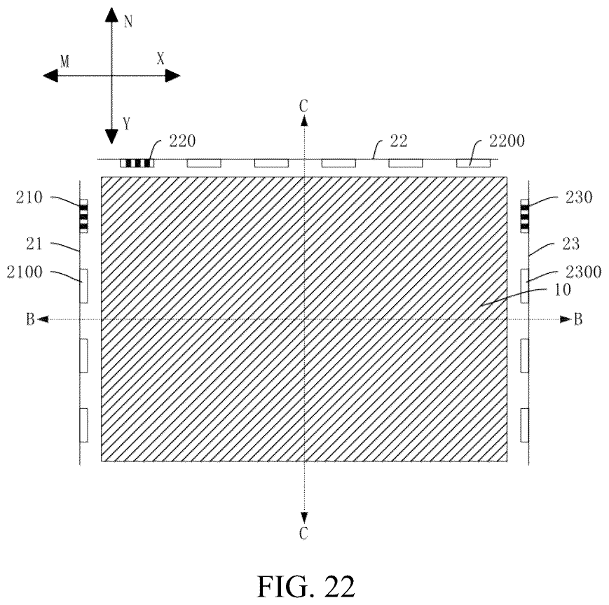

In another embodiment of the present application, with reference to FIGS. 22, 23, and 24, a difference of the present embodiment from the embodiment of FIG. 3 embodiment is that:
The backlight module further comprises a third light bar 23 disposed on a side surface of the first light guide plate 11. A light exiting direction of the third light bar 23 faces the first light guide plate 11 and emits light along the third direction M. The third direction M is opposite to the first direction X. The third light bar 23 comprises at least two third partitions 2300 and a third light emitting member 230 disposed in each of the third partitions 2300. When the backlight module is in the first state, brightness of adjacent two of the third partitions 2300 of the at least two third partitions 2300 is different.

It should be explained that the driver chip disposing method and the wiring connection method of the third light bar 23 can be configured by referring to the disposing method of the first driver chips 51 and the wiring connection method in the first light bar 21 in FIGS. 7, 8, and 9, or be configured by referring to a driving method of the first partitions 2100 in the first light bar 21 shown in FIGS. 10, 11, and 12, and no repeated description is here.

In the present embodiment, the first light bar 21 and the third light bar 23 are located respectively on two opposite side surfaces of the first light guide plate 11. The second light bar 22 is located on another side surface of the second light guide plate 12.

With reference to FIGS. 22, 23, 24, 25, 26, 27, and 28, the first light guide structures 111 and a plurality of third light guide structures 112 are disposed on a side of the first light guide plate 11 away from the light exiting surface 100. The third light guide structures 112 comprises a third light guide surface 1121 located near a side of the third light bar 23, and an included angle between the third light guide surface 1121 and a third direction N is less than 90°. the third light guide structures 112 further comprises a third rear surface 1122 disposed away from a side of the third light bar 23, and an included angle between the third rear surface 1122 and the first direction X is greater than an included angle between the third light guide surface 1121 and the third direction M such that light emitted from the third light bar 23 can converge in the first light guide plate 11. The second light guide structures 121 are disposed on a side of the second light guide plate 12 away from the light exiting surface 100.

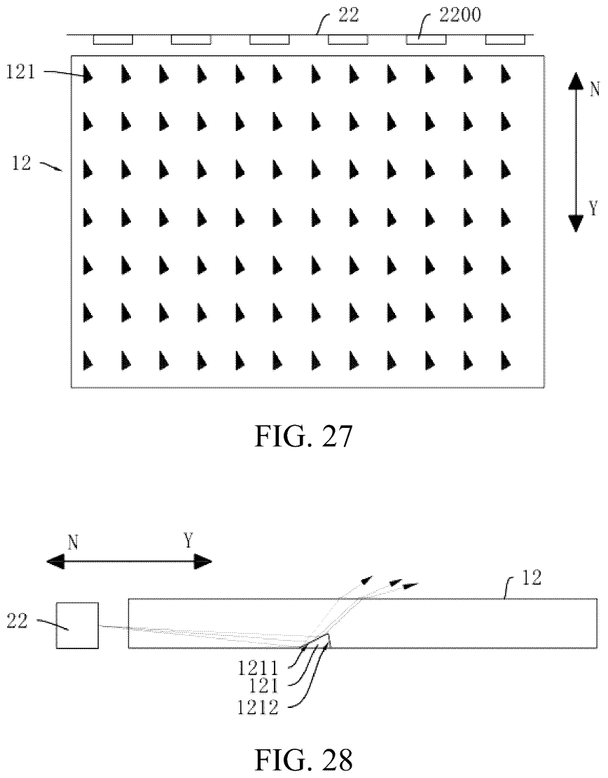

In an embodiment, the first light guide structures 111 disposed along the first direction X constitute a first light guide set, and the third light guide structures 112 disposed along the third direction M constitute a third light guide set. The first light guide plate 11 comprises the first light guide sets and the second light guide sets arranged alternately along the direction perpendicular to the first direction X, as shown in FIG. 22. The second light guide structures 121 arranged along the second direction Y constitute a second light guide set, the second light guide plate 12 comprises a plurality of second light guide sets arranged along the direction perpendicular to the second direction Y, as shown in FIG. 27.

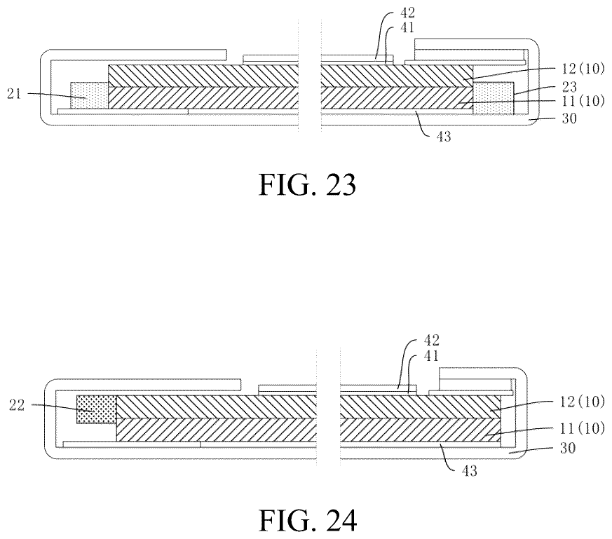

Furthermore, in another embodiment of the present application, a difference of the present embodiment from the embodiment in FIGS. 23 and 24 is that: the third light bar 23 is disposed on a side surface of the second light guide plate 12, and the third light bar 23 emits light toward the second light guide plate 12. The second light guide structures 121 comprises a third light guide surface disposed opposite to the third light bar 23. Alternatively, a plurality of third light guide structures are disposed on a surface of the second light guide plate 12 away from the light exiting side of the backlight module, and the third light guide structure comprises a third light guide surface disposed opposite to the third light bar 23.

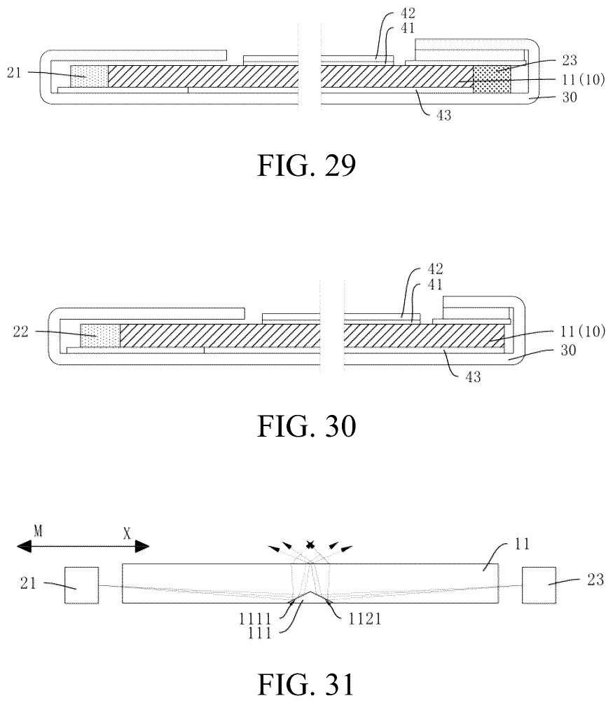

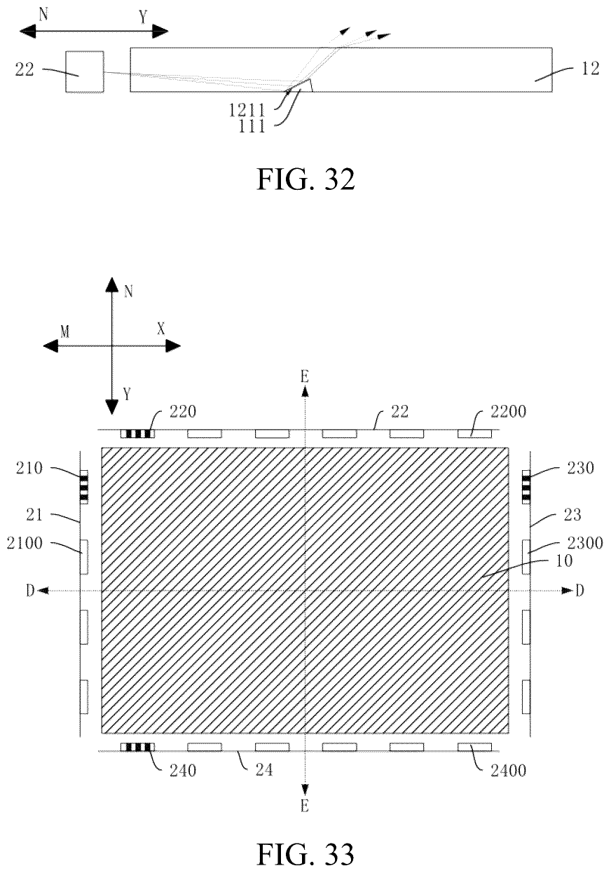

In another embodiment of the present application, with reference to FIG. 29, FIG. 30, FIG. 31 and FIG. 32, the light guide plate assembly 10 comprises a light guide plate. In particular, the light guide plate assembly 10 only comprises the first light guide plate 11. The first light bar 21, the second light bar 22, and the third light bar 23 are disposed on a side surface of the first light guide plate 11.

The first light guide structure 111 comprises a first light guide surface 1111 disposed opposite to the first light bar 21, a second light guide surface 1211 disposed opposite to the second light bar 22, and a third light guide surface 1121 disposed opposite to the third light bar 23. An included angle between the first light guide surface 1111 and the first direction X is less than 90°, an included angle between the second light guide surface 1211 and the second direction Y is less than 90°, and an included angle between the third light guide surface 1121 and the third direction M is less than 90°.

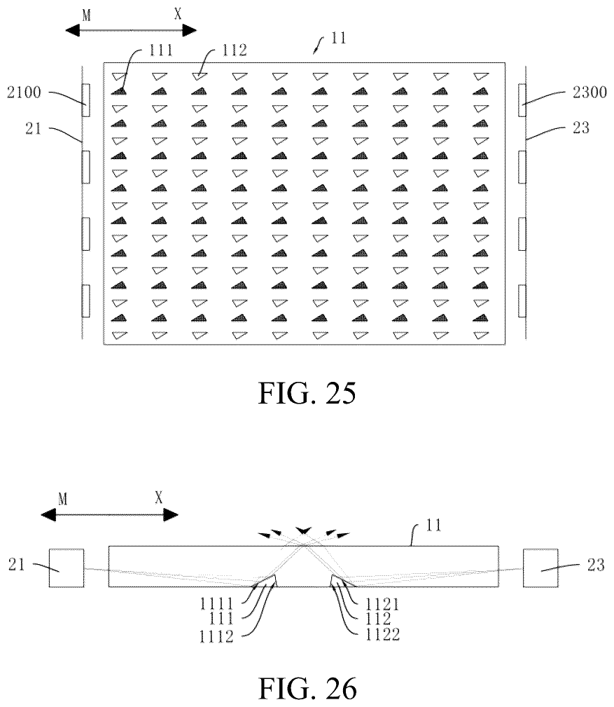

In another embodiment of the present application, with reference to FIGS. 25, 26, 33, 34, 35, 36, and 37, a difference of the present embodiment from the embodiment in FIG. 22 is that:
The backlight module further comprises a fourth the light bar 24 disposed on a side surface of the second light guide plate 12. A light exiting direction of the fourth the light bar 24 faces the second light guide plate 12 and emits light along the fourth direction N. The fourth direction Nis opposite to the second direction Y. The fourth the light bar 24 comprises at least two fourth partitions 2400 and at least one fourth light emitting member 240 disposed in each of the fourth partitions 2400. When the backlight module is in the first state, brightness of adjacent two of the fourth partitions 2400 in the at least two fourth partitions 2400 is different.

It should be explained that a driver chip disposing method and a wiring connection method of the third light bar 23 and the fourth the light bar 24 can be disposed with reference to the disposing method and the wiring connection method of the first driver chips 51 in the first light bar 21 in FIGS. 7, 8, and 9, or be disposed with reference to the driving method of the first partitions 2100 in the first light bar 21 in FIGS. 10, 11, and 12, and no repeated description is here.

In the present embodiment, the first light bar 21 and the third light bar 23 are located respectively on two opposite side surfaces of the first light guide plate 11, and the second light bar 22 and the fourth the light bar 24 are located respectively on two opposite side surfaces of the second light guide plate 12.

With reference to FIGS. 25, 26, 33, 34, 35, 36 and 37, the first light guide structures 111 and a plurality of third light guide structures 112 are disposed on a side of the first light guide plate 11 away from the light exiting surface 100. The third light guide structures 112 comprises a third light guide surface 1121 located near a side of the third light bar 23, and an included angle between the third light guide surface 1121 and a third direction N is less than 90°. the third light guide structures 112 further comprises a third rear surface 1122 disposed away from a side of the third light bar 23, and an included angle between the third rear surface 1122 and the first direction X is greater than an included angle between the third light guide surface 1121 and the third direction M such that light emitted from the third light bar 23 can converge in the first light guide plate 11.

A plurality of second light guide structures 121 and a plurality of fourth light guide structures 122 are disposed on a side of the second light guide plate 12 away from the light exiting surface 100. The fourth light guide structure 122 comprises a fourth light guide surface 1221 disposed near the fourth the light bar 24, and an included angle between the fourth light guide surface 1221 and the fourth direction N is less than 90°. The fourth light guide structure 122 further comprises a fourth rear surface 1222 disposed away from the fourth the light bar 24, and an included angle between the fourth rear surface 1222 and the second direction Y is greater than and an included angle between the fourth light guide surface 1221 and the fourth direction N such that light emitted from the fourth the light bar 24 can converge in the second light guide plate 12.

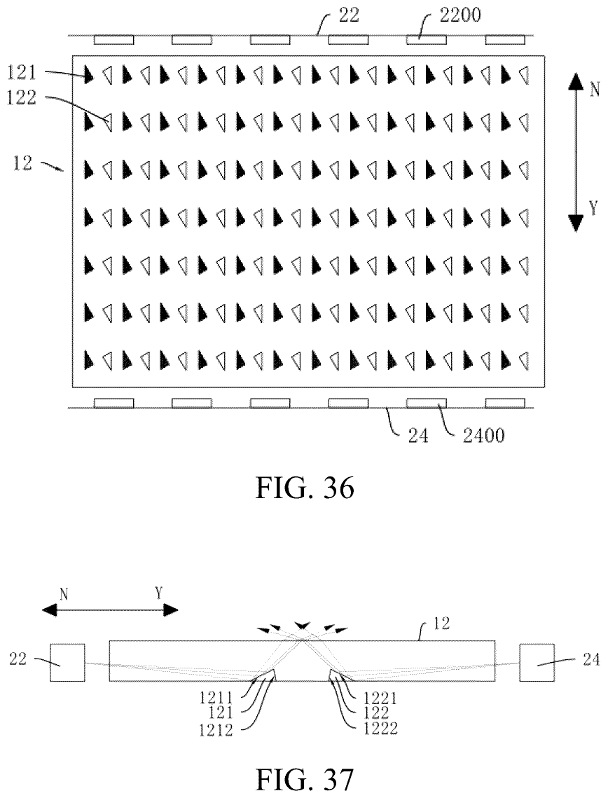

In an embodiment, the first light guide structures 111 disposed along the first direction X constitute a first light guide set, and the third light guide structures 112 disposed along the third direction M constitute a third light guide set. The first light guide plate 11 comprises the first light guide sets and the second light guide sets arranged alternately along the direction perpendicular to the first direction X, as shown in FIG. 25. The second light guide structures 121 arranged along the second direction Y constitute a second light guide set, the fourth light guide structures 122 along the fourth direction N constitute a fourth light guide set. The second light guide plate 12 comprises a plurality of second light guide sets and a plurality of fourth light guide sets arranged alternately along the direction perpendicular to the second direction Y, as shown in FIG. 36.

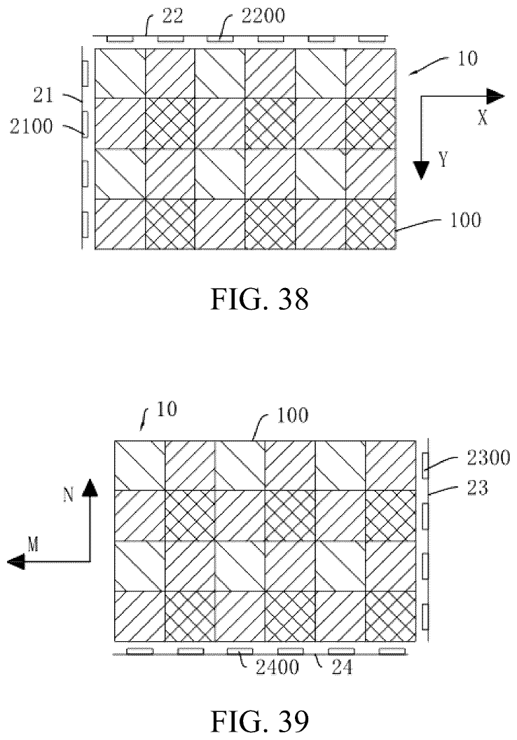

In an embodiment of the present application, with reference to FIGS. 38, FIGS. 39, 40, 41, 42, and 43, the first light bar 21 and the second light bar 22 forms a plurality of checkerboard lattice regions of different brightness in the light exiting surface 100 of the light guide plate assembly 10, for example, twenty-four checkerboard lattice regions, as shown in FIG. 38. Also, the third light bar 23 and the fourth the light bar 24 form a plurality of checkerboard lattice regions of different brightness in the light exiting surface 100 of the light guide plate assembly 10, for example, twenty-four checkerboard lattice regions, as shown in FIG. 39.

The at least two first partitions 2100 are aligned with the at least two third partitions 2300 along the first direction X, and the brightness of the first partitions 2100 and the third partitions 2300 aligned with each other along the first direction X is the same. The at least two second partitions 2200 are aligned with the at least two fourth partitions 2400 along the second direction Y, and brightness of the second partitions 2200 and the fourth partitions 2400 of aligned with each other along the second direction Y is the same.

Light emitted from one of the first partitions 2100 and one of the third partitions 2300 aligned with each other along the first direction X converges in the first light guide plate 11 to form a first light emitting region. Light emitted from one of the second partitions 2200 and one fourth partition 2300 aligned with each other along the second direction Y converges in the second light guide plate 12 to form a second light emitting region.

It can be understood that because light emitted from the first light emitting member 210, the second light emitting member 220, the third light emitting member 230, and the fourth light emitting member 240 comprises a certain divergence, and therefore a width of the first light emitting region is greater than a width of the first partition 2100 and a width of the third partition 2300, and a width of the second light emitting regions is greater than a width of the second partition 2200 and a width of the fourth partition 2400.

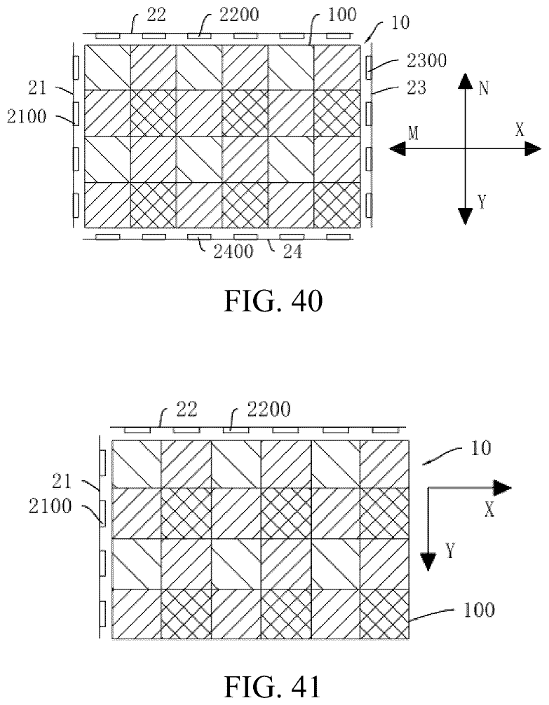

Thus, a quantity of the first light emitting regions and the second light emitting regions generated by the first light bar 21, the second light bar 22, the third light bar 23, and the fourth the light bar 24 finally overlapping each other in the checkerboard lattice regions in the light exiting surface 100 is also twenty-four, as shown in FIG. 40.

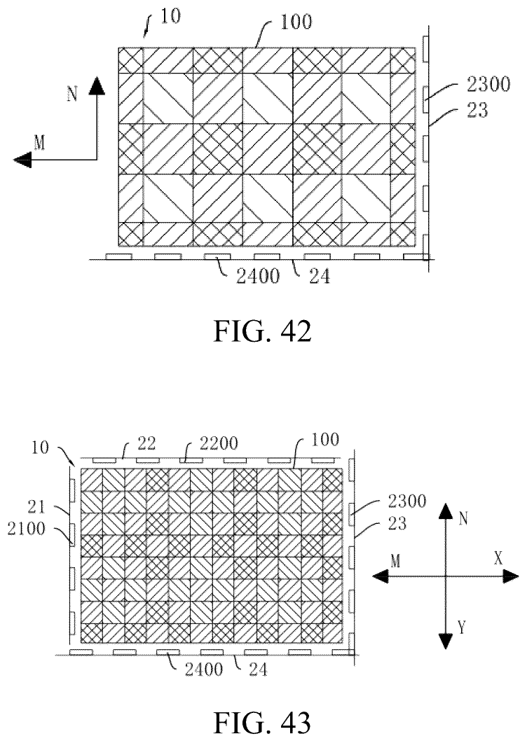

In another embodiment of the present application, the first light bar 21 and the second light bar 22 forms a plurality of checkerboard lattice regions of different brightness in the light exiting surface 100 of the light guide plate assembly 10, for example, twenty-four checkerboard lattice regions, as shown in FIG. 41. Also, the third light bar 23 and the fourth the light bar 24 form a plurality of checkerboard lattice regions of different brightness in the light exiting surface 100 of the light guide plate assembly 10, for example, thirty-five checkerboard lattice regions, as shown in FIG. 42.

The at least two first partitions 2100 are misaligned with the at least two third partitions 2300 along the first direction X. Each of the first partitions 2100 corresponds to a location between adjacent two of the third partitions 2300 along the first direction X, and the brightness of each of the first partitions 2100 is different from the brightness of adjacent two of the third partitions 2300 corresponding to the first partition 2100. The at least two second partitions 2200 are misaligned with the at least two fourth partitions 2400 along the second direction Y, each of the second partitions 2200 corresponds to a location between adjacent two of the fourth partitions 2400 along the second direction Y, and the brightness of each of the second partitions 2200 is different from the brightness of adjacent two of the fourth partitions 2400 corresponding to the second partition 2200.

It should be explained that because light emitted from the first light emitting member 210, the second light emitting member 220, the third light emitting member 230, and the fourth light emitting member 240 comprises a certain divergence. Therefore, orthographic projections of light emitted from adjacent ones of the first partitions 2100 and the third partitions 2300 along the first direction X comprise an overlap portion. Orthographic projections of light emitted from adjacent ones of the second partitions 2200 and the fourth partitions 2400 along the second direction Y comprise an overlap portion. Thus, orthographic projections of light emitted from one first partition 2100 and an adjacent third partition 2300 along the first direction X converge in the first light guide plate 11 to form at least two first light emitting regions with different brightness. Orthographic projections of light emitted from one second partition 2200 and an adjacent fourth partition 2400 along the second direction Y converge in the second light guide plate 12 to form at least two second light emitting regions with different brightness.

Thus, a quantity of the first light emitting regions and the second light emitting regions generated by the first light bar 21, the second light bar 22, the third light bar 23, and the fourth the light bar 24 finally overlapping each other in the checkerboard lattice regions in the light exiting surface 100 is ninety-six, as shown in FIG. 43.

As described above, the quantity of the checkerboard lattice regions formed on the light exiting surface 100 of the light guide plate assembly 10 can be adjusted according to a quantity of partitions and an alignment relationship of partitions of the first light bar 21, the second light bar 22, the third light bar 23 and the fourth the light bar 24 in the embodiment of the present application to obtain predetermined quantity the checkerboard lattice regions of a predetermined quantity to achieve local dimming functions for different demands. Also, each partition quantity in the embodiment of the present application is only for instance and explanation, but is not limited, and can be selected according to actual demands.

In another embodiment of the present application, a difference of the present embodiment from the embodiment of FIG. 37 is that: The second light guide structures 121 comprises a fourth light guide surface disposed opposite to the fourth the light bar 24.

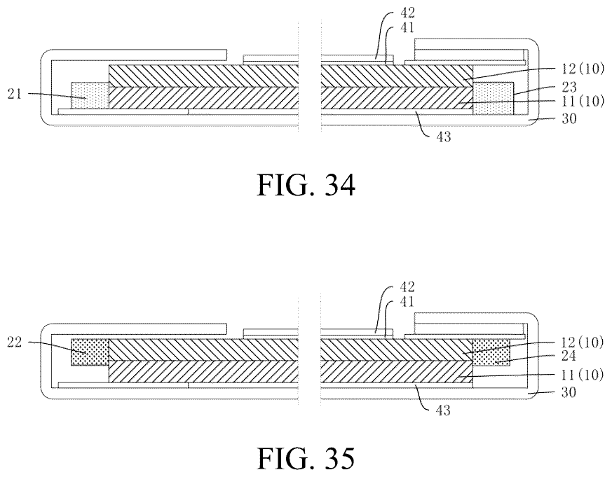

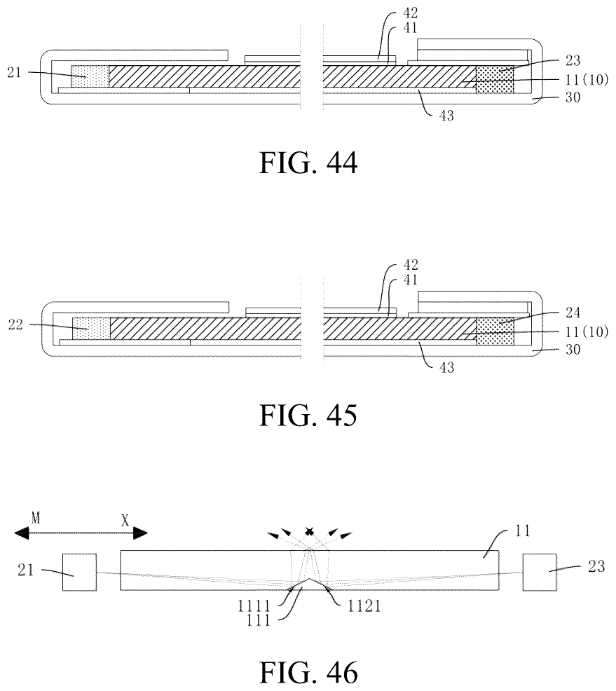

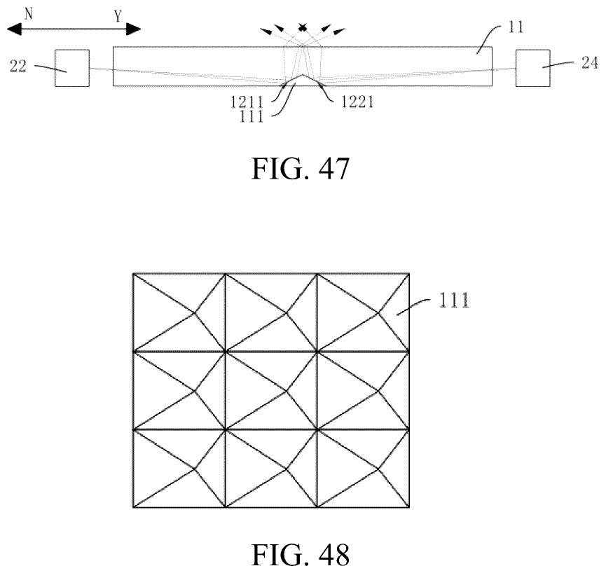

In another embodiment of the present application, with reference to FIGS. 33, 44, 45, 46, and 47, a difference of the present embodiment from the embodiment in FIG. 34 is that: The light guide plate assembly 10 comprises a light guide plate, in particular, the light guide plate assembly 10 only comprises the first light guide plate 11.

The first light bar 21, the second light bar 22, the third light bar 23, and the fourth the light bar 24 are disposed on a side surface of the first light guide plate 11. The first light guide structure 111 comprises a first light guide surface 1111 disposed opposite to the first light bar 21, a second light guide surface 1211 disposed opposite to the second light bar 22, a third light guide surface 1121 disposed opposite to the third light bar 23, and a fourth light guide surface 1221 disposed opposite to the fourth the light bar 24. An included angle between the first light guide surface 1111 and the first direction X is less than 90°, an included angle between the second light guide surface 1211 and the second direction Y is less than 90°, an included angle between the third light guide surface 1121 and the third direction M is less than 90°, and an included angle between the fourth light guide surface 1221 and the fourth direction N is less than 90°.

It should be explained that In the present embodiment, light bars are disposed on four side surfaces of the first light guide plate 11, and light guide surfaces are disposed on four side surfaces of the first light guide structures 111. The first light guide structures 111 can be a rectangular pyramid structure as shown in FIG. 48, and each pyramid surface corresponds to one light guide surface.

As described above, the embodiment of the present application disposes the first light bar 21 and the second light bar 22 on a side surface of the light guide plate assembly 10, and the light exiting direction of the first light bar 21 intersects the light exiting direction of the second light bar 22. Thus, when brightness of adjacent ones of the first partitions 2100 in the first light bar 21 is different and brightness of adjacent ones of the second partitions 2200 in the second light bar 22 is different, a checkerboard lattice light exiting surface having different brightness regions can be formed on a light exiting side of the light guide plate assembly 10, which can achieve a local dimming function of the backlight module and improve a contrast of the display device.

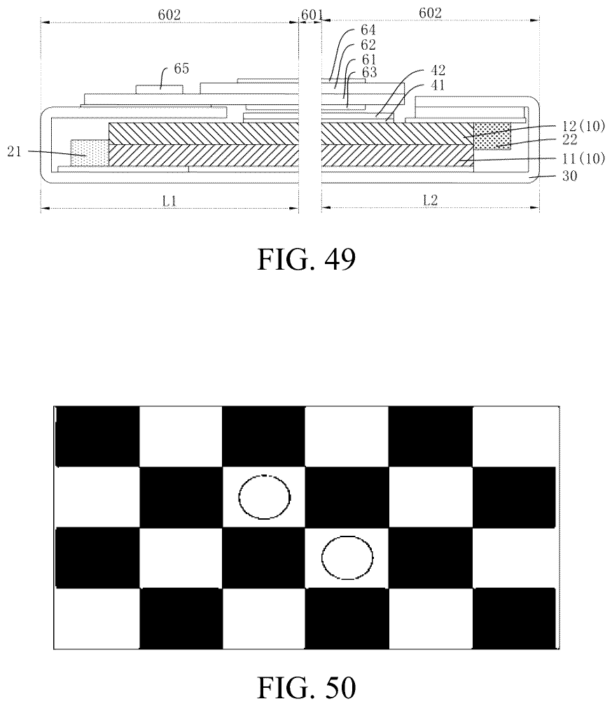

Furthermore, the embodiment of the present application further provides a display device, with reference to FIG. 49, the display device comprises a display panel and the backlight module as in the above embodiment. The display panel is disposed on a light exiting side of the backlight module.

In an embodiment, the display panel comprises an array substrate 61 and a color filter substrate 62 disposed opposite to each other, a lower polarizer 63 disposed on a side of the array substrate 61 away from the color filter substrate 62, an upper polarizer 64 disposed on a side of the color filter substrate 62 away from the array substrate 61, and a driver assembly 65 bonded to the array substrate 61.

The embodiment of the present application utilizes a design of a dual light guide plate structure, and light bars are disposed on at least two sides of the backlight module. Therefore, in the display device provided by the embodiment of the present application, compared to the backlight module in FIG. 1, a greater distance needs to be preserved in the frame in advance for disposing the light bar. With reference to FIG. 49, the display device comprises a display region 601 and a frame region 602 located adjacent to the display region 601. A width of the frame region 602 of a side of the display device configured for bonding the driver assembly 65 is greater than a width of the frame region 602 of another side of the display device. For example, in the related technology, a frame width of a bonding side is 6 mm, a frame width of another side is 2.5 mm. Then, in the embodiment of the present application, a width L1 of the frame region 602 configured for bonding the driver assembly 65 is 6 mm, and a width L2 of the frame region 602 of another side disposed with a light bar is 5 mm.

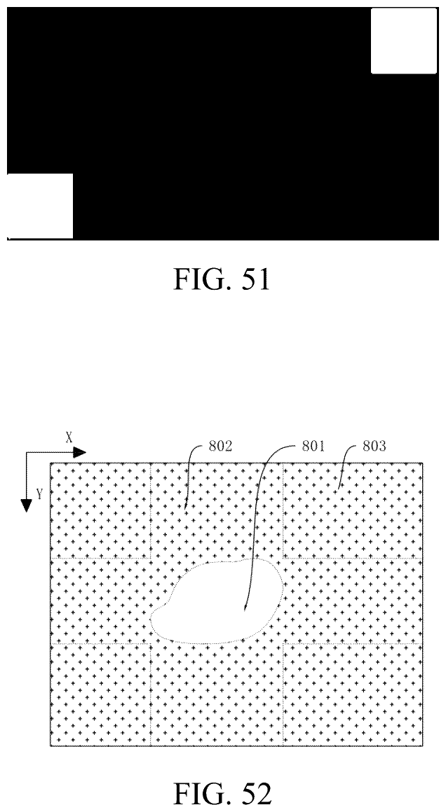

Furthermore, the embodiment of the present application implements to contrast verification the display device in FIGS. 1, 3, and 4. The display device in the embodiment comprises the backlight module as shown in FIGS. 3 and 4, the display device in a comparison example comprises the backlight module as shown in FIG. 1. In the embodiment and the comparison example, structures except for the backlight modules are the same, and verification is implemented to display devices of the embodiment and the comparison example. Also, the embodiment and the comparison example utilize two samples respectively for verification to obtain data as shown in the following Table 1 and Table 2. The data of Table 1 is display data of the embodiment and the comparison example illustrating a checkerboard lattice image as shown in FIG. 50. The data of Table 2 is display data of the embodiment and the comparison example illustrating contrasts of the edge and the angle in FIG. 51.

TABLE 1
Display device display data table

| | Comparison Example | | | Embodiment | | |
|---|---|---|---|---|---|---|
| | L0 | L255 | Contrast | L0 | L255 | Contrast |
| | brightness | image | CR | brightness | image | CR |
| Sample 1 | 0.42 | 610 | 1455 | 0.192 | 602 | 3133 |
| Sample 2 | 0.41 | 602 | 1478 | 0.189 | 608 | 3213 |

TABLE 2
Display device display data table

| | Comparison example | | | Embodiment | | |
|---|---|---|---|---|---|---|
| | L0 | L255 | Contrast | L0 | L255 | Contrast |
| | brightness | image | CR | brightness | image | CR |
| Sample 1 | 0.399 | 585 | 1466 | 0.120 | 553 | 4614 |
| Sample 2 | 0.392 | 579 | 1476 | 0.120 | 572 | 4750 |

It can be comprehended from the above Table 1 and Table 2 that utilization of the backlight module provided by the embodiment of the present application can drastically improve a contrast of the display device, and the contrasts on edges and corners can reach 4500 and more. Namely, the embodiment of the present application disposes the first light bar 21 and the second light bar 22 on a side surface of the light guide plate assembly 10, and the light exiting direction of the first light bar 21 intersects the light exiting direction of the second light bar 22. Thus, when brightness of adjacent ones of the first partitions 2100 in the first light bar 21 is different and brightness of adjacent ones of the second partitions 2200 in the second light bar 22 is different, a checkerboard lattice light exiting surface having different brightness regions can be formed on a light exiting side of the light guide plate assembly 10, which can achieve a local dimming function of the backlight module and effectively improve a contrast of the display device.

In an embodiment, display panel further comprises a liquid crystal layer (not shown in the figures) disposed between the array substrate 61 and the color filter substrate 62, and the compensation module. The compensation module is electrically connected to the array substrate 61 and/or the color filter substrate 62, and the compensation module is configured to control liquid crystal molecules in the liquid crystal layer to deflect to implement brightness compensation to different regions of the display device.

In an embodiment, the compensation module can be electrically connected to a pixel electrode and a common electrode in the display panel such that defection of the liquid crystal molecules in the liquid crystal layer can be controlled by controlling an electrical field formed between the pixel electrode and the common electrode. It can be understood that the pixel electrode and the common electrode can be disposed respectively on the array substrate 61 and the color filter substrate 62, and both also can be disposed on the array substrate 61, and no limit is applied.

It should be explained that because the first partitions 2100 of the first light bar 21 emit light along the first direction X and the second light bar 22 emits light along the second direction Y, the brightness of all regions aligned with the first partitions 2100 along the first direction X and the brightness of all regions aligned with the second partitions 2200 along the second direction Y in the light exiting surface of the backlight module would be influenced.

With reference to FIGS. 3 and 52, when the display device needs to display a special image, for example, the display device comprises a first region 801, a second region 802 aligned with the first region 801 along the first direction X and the second direction Y, and another region 803 located out of the first region 801 and the second region 802. The first region 801 requires greater first brightness, and the second region 802 and the other region 803 requires smaller and the same second brightness. Namely, the first brightness is greater than the second brightness. Because the first region 801 and the second region 802 emit light for the same ones of the first partitions 2100 and the second partitions 2200, when the first region 801 requires the greater first brightness, the light emitting brightness of corresponding ones of the first partitions 2100 and the second partitions 2200 is greater such that the brightness of the second region 802 is influenced and cannot be reduced to the second brightness. Thus, the brightness of the second region 802 would be greater than the second brightness, namely, the brightness of the second region 802 is greater than the brightness of the other region 803, thereby resulting in uneven display of the display device. Furthermore, the liquid crystal molecules in the liquid crystal layer can be controlled by the compensation module to deflect. Namely the liquid crystal molecules in the second region 802 are controlled to deflect to reduce light through the second region 802 to lower the brightness of the second region 802 to the second brightness to compensate the brightness of the second region 802 to implement the display image required by the display device.

In an embodiment, the compensation module can be an additional driver chip, or be integrated in the driver assembly 65, and obtain a compensation region required to be compensated by comparing light emitting brightness data of the backlight module to display image data of the display device. Then, the compensation module, by controlling liquid crystal molecules in the compensation region to deflect, controls a light amount passing through the compensation region to be able to further adjust brightness of the compensation region to implement brightness compensation to the compensation region.

In the above-mentioned embodiments, the descriptions of the various embodiments are focused. For the details of the embodiments not described, reference may be made to the related descriptions of the other embodiments.

The backlight module and the display device provided by the embodiment of the present application are described in detail as above. The principles and implementations of the present application are described in the following by using specific examples. The description of the above embodiments is only for assisting understanding of the technical solutions of the present application and the core ideas thereof. Those of ordinary skill in the art should understand that they can still modify the technical solutions described in the foregoing embodiments or equivalently replace some of the technical features. These modifications or replacements do not make the essence of the technical solutions depart from a range of the technical solutions of the embodiments of the present application.

What is claimed is:

1. A backlight module, comprising:
a light guide plate assembly, wherein the light guide plate assembly comprises a collimation-type light guide plate;
a first light bar disposed on a side surface of the light guide plate assembly, wherein a light exiting direction of the first light bar faces the light guide plate assembly and emits light along a first direction; and
a second light bar disposed on a side surface of the light guide plate assembly, wherein a light exiting direction of the second light bar faces the light guide plate assembly and emits light along a second direction, and the first direction intersects the second direction;
wherein the first light bar comprises at least two first partitions and a first light emitting member disposed in each of the first partitions, the second light bar comprises at least two second partitions and a second light emitting member disposed in each of the second partitions, the backlight module comprises a first state, when the backlight module is in the first state, brightness of adjacent two of the first partitions in the at least two first partitions is different, and brightness of adjacent two of the second partitions in the at least two second partitions is different.

2. The backlight module according to claim 1, wherein the light guide plate assembly comprises a first light guide plate, the first light bar is disposed on a side surface of the first light guide plate, and the light exiting direction of the first light bar faces the first light guide plate, a plurality of first light guide structures are disposed on a surface of the first light guide plate away from a light exiting side of the backlight module, and the first light guide structure comprises a first light guide surface disposed opposite to the first light bar.

3. The backlight module according to claim 2, wherein the second light bar is disposed on a side surface of the first light guide plate, the light exiting direction of the second light bar faces the first light guide plate, and the first light guide structure comprises a second light guide surface disposed opposite to the second light bar;
or, the light guide plate assembly further comprises a second light guide plate stacked with the first light guide plate, the second light bar is disposed on a side surface of the second light guide plate, the light exiting direction of the second light bar faces the second light guide plate, a plurality of second light guide structures are disposed on a surface of the second light guide plate away from the light exiting side of the backlight module, and the second light guide structure comprises a second light guide surface disposed opposite to the second light bar.

4. The backlight module according to claim 3, wherein an included angle between the first light guide surface and the first direction is less than 90°, and an included angle between the second light guide surface and the second direction is less than 90°.

5. The backlight module according to claim 3, wherein the backlight module further comprises a third light bar disposed on the light guide plate assembly side surface, a light exiting direction of the third light bar faces the light guide plate assembly and emit light along a third direction, and the third direction is opposite to the first direction; and
wherein the third light bar comprises at least two third partitions and a third light emitting member disposed in each of the third partitions, and when the backlight module is in the first state, brightness of adjacent two of the third partitions in the at least two third partitions is different.

6. The backlight module according to claim 5, wherein the third light bar is disposed on a side surface of the first light guide plate and emit light toward the first light guide plate, and the first light guide plate comprises a third light guide surface disposed opposite to the third light bar.

7. The backlight module according to claim 6, wherein a plurality of third light guide structures are disposed on the surface of the first light guide plate away from the light exiting side of the backlight module, the third light guide structure comprises the third light guide surface disposed opposite to the third light bar, wherein the first light guide structures disposed along the first direction constitute a first light guide set, the third light guide structures disposed along the third direction constitute a third light guide set, the first light guide plate comprises a plurality of the first light guide sets and a plurality of second light guide sets arranged alternately along a direction perpendicular to the first direction;
or, the first light guide structure comprises the third light guide surface disposed opposite to the third light bar.

8. The backlight module according to claim 5, wherein the third light bar is disposed on a side surface of the second light guide plate and emits light toward the second light guide plate, and the second light guide plate comprises a third light guide surface disposed opposite to the third light bar.

9. The backlight module according to claim 5, wherein the at least two first partitions are aligned with the at least two third partitions along the first direction, and brightness of the first partitions and the third partitions aligned with each other along the first direction is the same; and
or, the at least two first partitions are misaligned with the at least two third partitions along the first direction, each of the first partitions corresponds to a location between adjacent two of the third partitions along the first direction, and brightness of each of the first partitions is different from brightness of the adjacent two of the third partitions corresponding to the first partition.

10. The backlight module according to claim 5, wherein the backlight module further comprises a fourth light bar disposed on the light guide plate assembly side surface, a light exiting direction of the fourth light bar faces the light guide plate assembly along emits light along a fourth direction, and the fourth direction is opposite to the second direction;
wherein the fourth light bar comprises at least two fourth partitions and at least one fourth light emitting member disposed in each of the fourth partitions, and when the backlight module is in the first state, adjacent brightness of two of the fourth partitions in the at least two fourth partitions is different.

11. The backlight module according to claim 10, wherein the fourth light bar is disposed on a side surface of the first light guide plate and emit light toward the first light guide plate, and the first light guide structure comprises a fourth light guide surface disposed opposite to the fourth light bar.

12. The backlight module according to claim 10, wherein the fourth light bar is disposed on a side surface of the second light guide plate and emits light toward the second light guide plate, the second light guide plate comprises a fourth light guide surface disposed opposite to the fourth light bar.

13. The backlight module according to claim 12, wherein a plurality of fourth light guide structures are disposed on a side surface of the second light guide plate away from the light exiting side of the backlight module, the fourth light guide structure comprises a fourth light guide surface disposed opposite to the fourth light bar, wherein the second light guide structures arranged along the second direction constitute a second light guide set, the fourth light guide structures arranged along the fourth direction constitute a fourth light guide set, and the second light guide plate comprises the second light guide sets and the fourth light guide sets arranged alternately along a direction perpendicular to the second direction;
or, the second light guide structure comprises the fourth light guide surface disposed opposite to the fourth light bar.

14. The backlight module according to claim 10, wherein the at least two second partitions are aligned with the at least two fourth partitions along the second direction, brightness of the second partitions and the fourth partitions aligned with each other along the second direction is the same;
or, the at least two second partitions are misaligned with the at least two fourth partitions along the second direction, each of the second partitions along the second direction corresponds to a location between adjacent two of the fourth partitions, and brightness of each of the second partitions is different from brightness of adjacent two of the fourth partitions corresponding to the second partition.

15. The backlight module according to claim 1, wherein the backlight module comprises a plurality of first driver chips and a plurality of the second driver chips, the first driver chips are electrically connected to the first light emitting members in the first partitions, and the second driver chips are electrically connected to the second light emitting members in the second partitions;
adjacent two of the first partitions are connected to different ones of the first driver chips, and adjacent two of the second partitions are connected to different ones of the second driver chips.

16. The backlight module according to claim 1, wherein a light emitting angle of the first light emitting member is less than or equal to 120°, and a light emitting angle of the second light emitting member sis less than or equal to 120°.

17. The backlight module according to claim 1, wherein a light exiting side of the light guide plate assembly near the backlight module comprises light exiting surface;
when the backlight module is in the first state, the light exiting surface comprises a plurality of first light emitting regions extending along the first direction arranged along a direction perpendicular to the first direction, light emitting brightness of adjacent two of the first light emitting regions is different, and each of the first light emitting regions along the first direction corresponds to one of the first partitions;
the light exiting surface comprises a plurality of second light emitting regions extending along the second direction and arranged along a direction perpendicular to the second direction, light emitting brightness of adjacent two of the second light emitting regions is different, and each of the second light emitting regions along the second direction corresponds to one of the second partitions.

18. The backlight module according to claim 1, wherein the first light bar comprises a plurality of the first partitions, and light emitting brightness of each of the first partitions is one of at least three different brightness; and
the second light bar comprises a plurality of second partitions, and light emitting brightness of each of the second partitions is one of at least three different brightness.

19. A display device, wherein the display device comprises a backlight module and a display panel, and the display panel is disposed on a light exiting side of the backlight module;
the backlight module comprises:
a light guide plate assembly, wherein the light guide plate assembly comprises a collimation-type light guide plate;
a first light bar disposed on a side surface of the light guide plate assembly, wherein a light exiting direction of the first light bar faces the light guide plate assembly and emits light along a first direction; and
a second light bar disposed on a side surface of the light guide plate assembly, wherein a light exiting direction of the second light bar faces the light guide plate assembly and emits light along a second direction, and the first direction intersects the second direction;
wherein the first light bar comprises at least two first partitions and a first light emitting member disposed in each of the first partitions, the second light bar comprises at least two second partitions and a second light emitting member disposed in each of the second partitions, the backlight module comprises a first state, when the backlight module is in the first state, brightness of adjacent two of the first partitions in the at least two first partitions is different, and brightness of adjacent two of the second partitions in the at least two second partitions is different.

20. The display device according to claim 19, wherein the display panel comprises an array substrate and a color filter substrate disposed opposite to each other, a liquid crystal layer disposed between the array substrate and the color filter substrate, and a compensation module, the compensation module is electrically connected to the array substrate and/or the color filter substrate, the compensation module is configured to control liquid crystal molecules in the liquid crystal layer to deflect to compensate brightness of different regions of the display device.
